(19) United States
(12) Patent Application Publication
(10) Pub. No.: US 2024/0283632 A1
(43) Pub. Date: Aug. 22, 2024

(54) Private Retrieval of Location-Based Information

(71) Applicant: Apple Inc., Cupertino, CA (US)

(72) Inventors: Rehan Rishi, San Francisco, CA (US); Fabian K. Boemer, Mountain View, CA (US); Karl Tarbe, Cupertino, CA (US); Brandon J. Van Ryswyk, Mountain View, CA (US); Marco Zuliani, Willow Glen, CA (US); Abhishek (APS) Bhowmick, Sunnyvale, CA (US); Tancrède Lepoint, New York, NY (US)

(21) Appl. No.: 18/421,778

(22) Filed: Jan. 24, 2024

Related U.S. Application Data
(60) Provisional application No. 63/485,648, filed on Feb. 17, 2023.

(51) Int. Cl. H04L 9/00; H04W 8/26; H04W 12/04

(52) U.S. Cl. CPC H04L 9/008; H04W 8/26; H04W 12/04

(57) ABSTRACT

A computing device sends a request for location-based information (LBI) to a server, where the request includes first address information indicative of a geographic area (e.g., where the computing device is located), and an encrypted version of second address information that specifies a sub-region of the geographic area. The second address information is encrypted by a first key not accessible to the server. The first address information is used to select a subset of the LBI stored on the server. The server then performs a privacy protocol such as Private Information Retrieval on the selected subset using the encrypted second address information. This produces an encrypted version of the requested LBI without the server having access to information indicating which item of LBI was requested. The encrypted version of the particular item of LBI is returned to the computing device, where it can be decrypted using a second key.

### PRIORITY CLAIM

This application claims priority to U.S. Provisional Application No. 63/485,648 entitled “Private Retrieval of Location-Based Information” filed on Feb. 17, 2023, which is incorporated by reference herein in its entirety.

### BACKGROUND

### Technical Field

This disclosure relates generally to location-based information, and more specifically, to retrieving location-based information from a server while preserving privacy.

### Description of the Related Art

Modern mobile computing devices commonly include hardware that allows the devices to accurately determine their geophysical location. For example, many cell phones can use a combination of cellular signal strength and/or a global positioning system (GPS) receiver in order to accurately determine their location. A computing device can then provide information indicative of its location to various servers in order to obtain information pertinent to its location.

Such information is referred to as location-based information (LBI), and services that handle sending and retrieving LBI are referred to as location-based services. Location-based services provide targeted information to users in real time. The specified location is often a user's current location. Maps and navigation apps are one type of location-based service. Other such services include those that recommend nearby social events, track devices or friends, provide information on nearby businesses, etc.

Generally speaking, a location-based service on a computing device will provide location information (e.g., latitude/longitude) to a server, and receive LBI in return. A weather app, for example, communicates with a server that stores weather data for many different locations. When contacted by a particular computing device, the server will retrieve weather data that corresponds to the supplied coordinates and return it to the particular computing device.

### BRIEF DESCRIPTION OF THE DRAWINGS

FIG. 1 is a block diagram of a system for storing and retrieving location-based information.

FIGS. 2A-E provide example uses of a Geohashing scheme.

FIG. 2F illustrates different examples of first and second address information sent from computing device 110 to server 120.

FIGS. 2G-H illustrate example formats of requests from computing device 110 to LBI server 120.

FIG. 3 is a block diagram of one embodiment of LBI server 120.

FIGS. 4A-B are block diagrams illustrating one embodiment of a Private Information Retrieval (PIR) protocol that may be performed by LBI server 120.

FIGS. 5A-B illustrate different data organization schemes that may be employed by a data store within LBI server 120.

FIG. 6 is a block diagram of one embodiment of computing device 110 that is configured to request LBI from LBI server 120.

FIG. 7 is a flow diagram of one embodiment of a method performed by LBI server 120 for servicing an LBI request.

FIG. 8 is a flow diagram of one embodiment of a method performed by computing device 110 to request LBI from LBI server 120.

### DETAILED DESCRIPTION

Location-based services provide valuable information to users of computing devices. Using these services, however, can entail making frequent requests for current information. Some location-based services, for example, may request updated LBI as often as once every 15 minutes.

The use of location-based services can thus come at a cost. For example, if a user's location (or a location of interest to a user) is stored by an LBI server that is compromised as part of a data breach, some of the user's LBI may be made public or sold to bad-faith actors that may use the location for identity theft or other criminal activity. More generally, users may not wish to provide location information to a third-party in order to preserve privacy. Given these potential drawbacks, some users may choose not to use location-based services, thus depriving themselves of potentially useful information and leading to a reduced user experience.

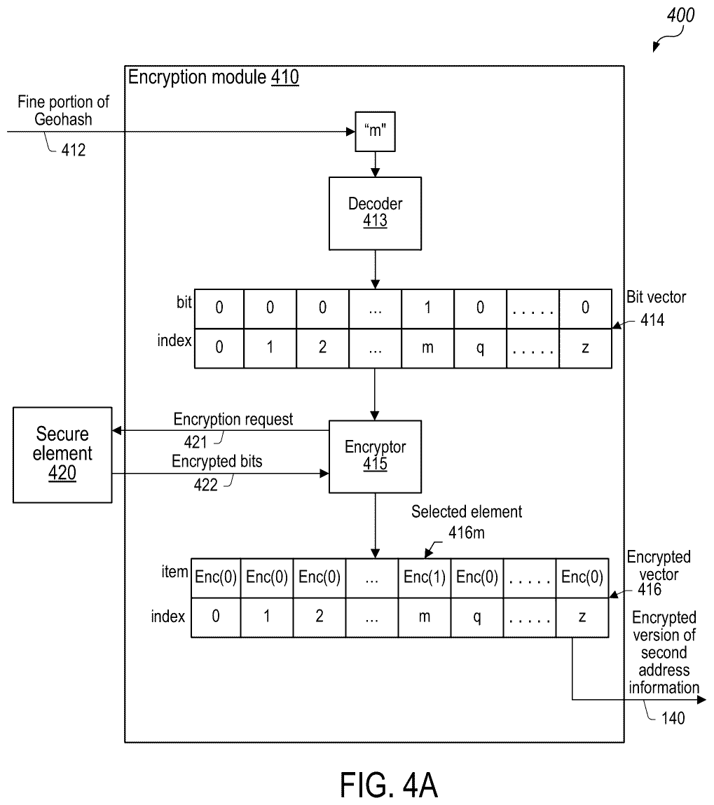

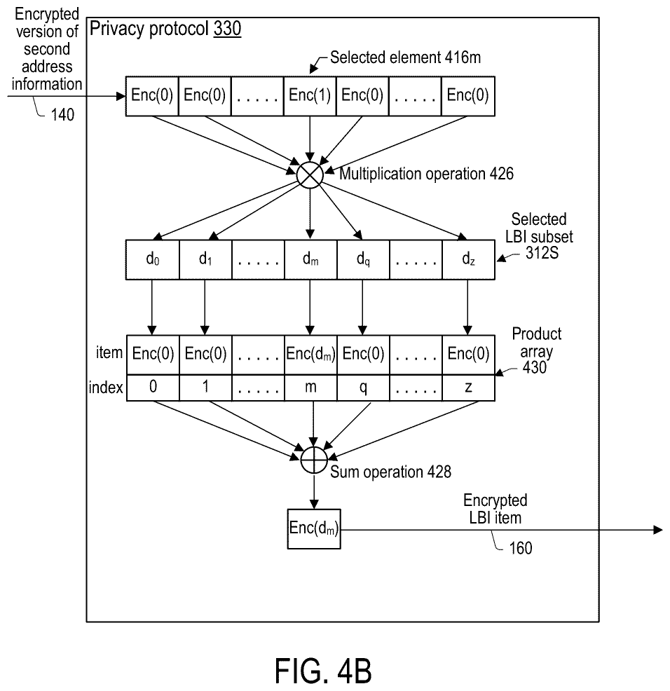

Accordingly, the inventors have recognized that it would be desirable to provide a method for accessing LBI that addresses these privacy concerns. As an initial matter, the inventors recognized that the use of a protocol such as private information retrieval (PIR) can be advantageously employed to retrieve LBI. As will be described further below with respect to FIGS. 4A-B, PIR allows information to be retrieved from a data store using parameters, but without the data store learning the values of those parameters (thus providing privacy). The inventors have further recognized, however, that the use of PIR is resource-intensive, and thus may not be practical with a large amount of data. For example, the inventors recognized that performing PIR with weather data that spans the entire globe may be too resource-intensive. Accordingly, PIR may not be able to be performed with a desired amount of latency. To address this concern, the inventors propose a paradigm in which an LBI data store is addressed using multiple different addresses or indexes that have differing amounts of precision. One address/index is used to select a subset of the LBI, and another address/index is used to perform a protocol such as PIR to actually retrieve the LBI from the selected subset.

For example, an LBI data store may be addressed using “first address information” and “second address information,” where the first address information is indicative of a first region (e.g., a region in which the computing device is located), and the second address is indicative of a second, more specific region (i.e., a sub-region of the first region) in which the computing device is located. Thus, in one implementation, the first region specified by the first address information might include the entire San Francisco Bay Area, while the second region specified by the second address information might be limited to the city of San Francisco proper. In some embodiments, the first and second address information may constitute or correspond to Geohash addresses, as will be described below. Note that a geographic location for which LBI is desired need not correspond to the user's current location; more generally, LBI can be requested for any specified geographic location of interest to the user.

In this example, the first address information is provided to the LBI data store, and is used to reduce the size of the problem space by selecting a subset of the LBI on which to further operate. The second address information is sent to the LBI data store in an encrypted format that is not decryptable by the data store. The data store then uses the encrypted second address information to perform a privacy protocol such as PIR on the selected subset of LBI in order to retrieve encrypted LBI, which can then be returned to the computing device and decrypted. This paradigm thus achieves a tradeoff that allows the use of LBI without providing precise location information of the computing device to a third-party system.

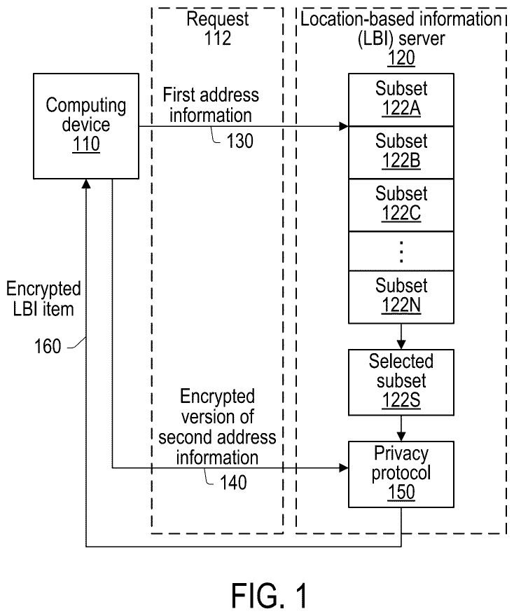

This paradigm is illustrated in FIG. 1, which depicts a block diagram of a system 100. As shown, system 100 includes a computing device 110, which is connected (typically wirelessly) to an LBI server 120. As will be described, computing device 110 supplies location information to server 120, and receives LBI in return.

Computing device 110 is any device configured to electronically send location information and receive LBI in return. Generally speaking, device 110 is a mobile computing device, meaning that it is portable and thus can be operated in various locations. Cellular phones, tablets, and GPS navigations system are examples of computing device 110. In some cases, computing device 110 may have specific hardware (e.g., a GPS receiver) that helps determine a current position of the device. As will be described below, device 110 may also be capable of executing software to execute one or more location-based services that can communicate address information indicative of device 110's determined position to LBI server. Device 110 may further include specialized circuitry that can assist with cryptographic operations.

Location-based information (LBI) server 120, in the illustrated embodiment, stores LBI 122. LBI 122 can be any type of information (weather, traffic, merchant information, etc.), and it can be stored in various formats (numeric, alphanumeric, image, etc.). As will be described, LBI 122 is addressable at different levels of granularity/precision. Accordingly, address information presented to LBI server 120 can be used to specify a subset of the total amount of LBI stored by server 120. Subsets in FIG. 1 are denoted by reference numerals 122A-N. Suppose that a 6-character address uniquely identifies a piece of LBI at the most granular level stored in server 120 (i.e., there are 26 or 64 different “pieces” or “items” of LBI stored by server 120). If the three most-significant characters of the address are used to access server 120, these characters will identify one of eight different subsets within server 120, each storing eight different pieces of LBI.

FIG. 1 illustrates this process. Computing device 110 sends a request 112 to server 120. Request 112 includes first address information 130 and second address information 140. First address information 130, which corresponds to a first geographic region, is used to select one of subsets 122 of LBI from server 120. The selected subset is denoted as subset 122S in FIG. 1.

Selected subset 122S is provided as an input to a privacy protocol 150 (e.g., PIR) that also takes as an input second address information 140, which corresponds to second, more specific geographic region. The selection of subset 122S reduces the problem space that privacy protocol 150 is to operate on. (As noted above, protocol 150 may be resource-intensive and thus impractical to run using the entirety of LBI stored by server 120.)

Significantly, second address information 140 is encrypted in a format that is not decryptable by server 120. Privacy protocol 150 thus operates to select one or more pieces of LBI from within subset 122S based on second address information 140. (Note that request 112 might be encrypted in its entirety in a format that is decryptable by server 120. In such a scenario, second address information 140 would be further encrypted within request 112 in a format that is not decryptable by server 120. On the other hand, regardless of whether request 112 is encrypted, the constituent first address information 130 within request 112 is either unencrypted or encrypted in a format that is decryptable by server 120.)

The output of privacy protocol 150 is encrypted LBI item 160, which includes the requested piece of LBI for computing device 110. The requested piece of LBI corresponds to the second, more specific region. LBI item 160 is encrypted in a manner that is decryptable by computing device 110. In some implementations, encrypted LBI item 160 includes a single piece or item of LBI for the second, more specific region corresponding to second address information 140. As used herein, references to a “piece” or “item” of LBI refers to LBI for a single sub-region specified at the granularity of the second address information. Such an “item” of LBI can include multiple different types of LBI (e.g., an item of LBI can include weather, traffic, and merchant information, for example). In other implementations, multiple pieces of LBI may be included in encrypted LBI item 160. In some cases, this extra LBI may be cached at computing device 110. If device 110 subsequently moves out of the second region to an adjacent region corresponding to one of the cached pieces of LBI (or the user is simply requesting cached LBI independent of the location of device 110), device 110 can present the cached LBI to the user without making a request to server 120.

Upon receipt, computing device 110 is able to decrypt encrypted LBI item 160 and present the decrypted LBI to the user. To recap, LBI server 120 is provided, in the clear (i.e., in plaintext), only a general idea of the user's location or the location of interest (first address information 130). The indication of the more specific location (second address information 140) is not available to server 120 in the clear. Nonetheless, because of the use of privacy protocol 150, computing device 110 can receive the requested LBI without LBI server 120 having knowledge of the more specific location, thus providing a degree of privacy to the user of device 110 while still affording the benefits of location-based services.

FIG. 1 thus describes a paradigm in which a repository of location-based information such as server 120 is addressed using two different values: first address information 130 corresponds to a more general first geographic region and is used to select a subset of the LBI stored by server 120, and second address information 140 corresponds to a second, more specific region within the first region and is used to select the LBI corresponding to the second region from within the selected subset.

The phrase “address information” is a broad phrase intended to cover an entire address, a portion of an address, information derived from the address, or information indicative of an address, where the “address” is a value used to specify a location in a data store at the LBI server, in much the same way a memory address specifies a location in a computer memory. The address in question can take any suitable form, such as a geocode. A geocode is a value that represents a geographic entity (e.g., a geographic region) and distinguishes it from other geographic entities.

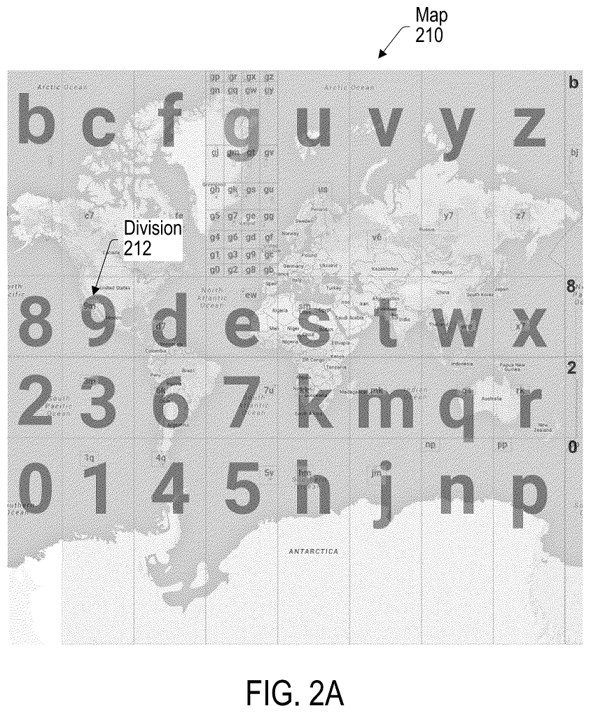

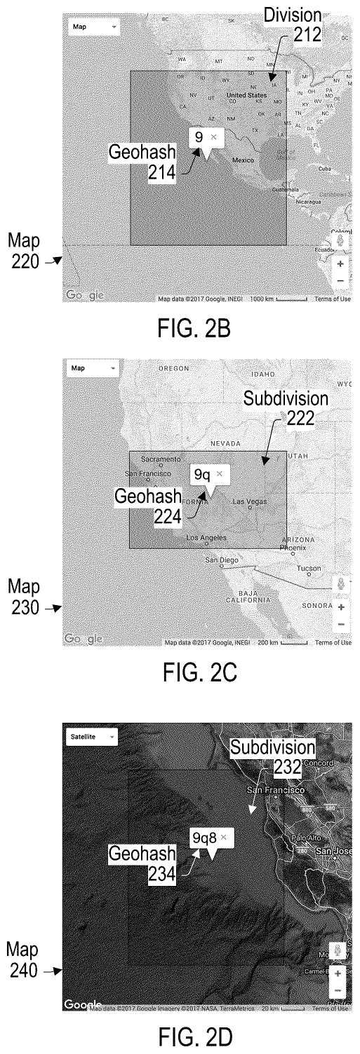

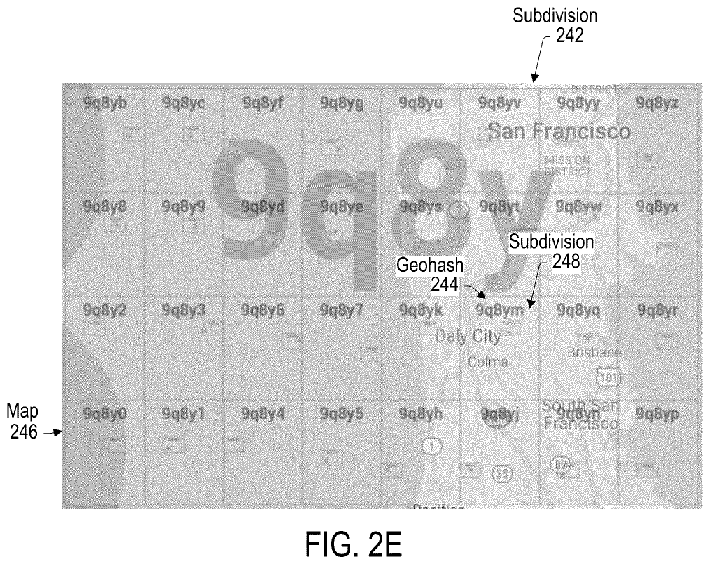

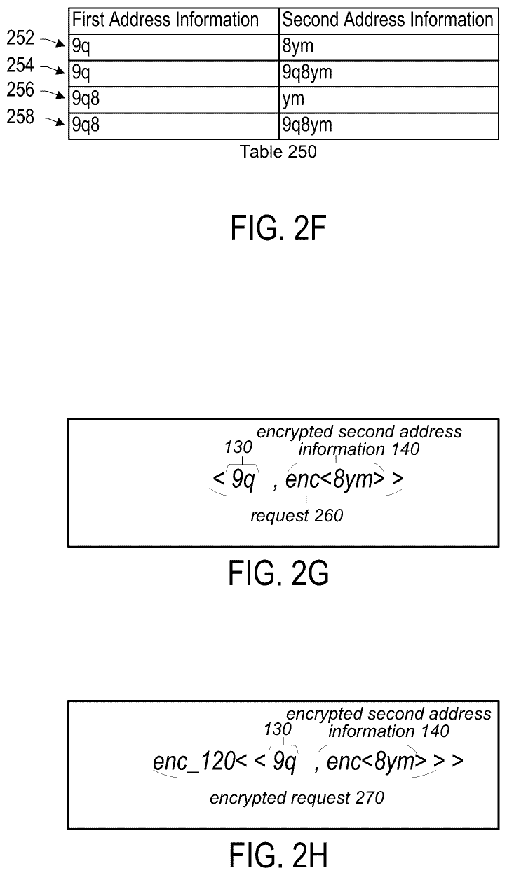

One type of geocode is the Geohash scheme. The Geohashing scheme subdivides a given geographic space into different sections, each of which can be represented using an alphanumeric character. Geohash uses the digits 0-9, as well as 22 alphabetic characters (“a,” “i,” “l,” and “o” are not used), with the result that the given geographic space can divided into 32 sections or subdivisions. Each section in turn can be further subdivided into additional sections, each of which can in turn be represented by another alphanumeric character. This subdivision of sections can be done an arbitrary number of times. (Accordingly, a given Geohash character represents five binary bits of information, since 2⁵=32.) The string of alphanumeric characters that specifies a particular geographic region can be referred to as a Geohash, a Geohash value, or a Geohash address. The longer a Geohash (or the greater the “bit depth”), the more precise the specification of the geographic area—each additional bit in a Geohash indicates a further division of a geographic region. FIGS. 2A-D illustrate the Geohashing address scheme in more detail.

FIG. 2A illustrates a map 210 of the world with 32 divisions, each of which is represented by an alphanumeric character. As can be seen, the divisions on the left side of map 210 wrap around and are thus also found on the right side of map 210. One particular division that includes a large part of the United States is indicated by reference numeral 212. In the Geohash scheme, this top-level division corresponds to the alphanumeric character “9,” (indicated by reference numeral 214). Accordingly, if one entity provides a Geohash value of 9 to another entity, that value can be used to identify division 212 from top-level map 210. As will be shown, each of the 32 top-level divisions of map 210 is further subdivided into 32 sub-regions at the next level of precision. This subdivision can continue to a very fine degree of precision. For example, an eight-character Geohash may be capable of identifying an individual residence.

FIGS. 2B-D illustrate further levels of subdivisions within top-level division 212. Map 220 in FIG. 2B shows division 212 from map 210, only in more detail. As with the 32 divisions shown within map 210, division 212 also includes 32 further subdivisions, although these are not shown in map 220. One of these subdivisions is subdivision 222, which corresponds to a sub-region represented by the alphanumeric character “q.” Accordingly, subdivision 222 can be uniquely specified within the Geohashing scheme by the address 9q (indicated by reference numeral 224). As shown in map 230 in FIG. 2C, subdivision 222 covers parts of California, Nevada, Utah, and Arizona.

Subdivision 222 can be partitioned into 32 further subdivisions (not shown in FIG. 2C). One of these subdivisions is subdivision 232, which corresponds to a sub-region represented by the alphanumeric character “8.” Accordingly, subdivision 232 can be uniquely specified within the Geohashing scheme by the address 9q8 (indicated by reference numeral 234). As shown in map 240 in FIG. 2D, subdivision 232 covers San Francisco and portions of the Pacific Ocean.

Subdivision 232 can be partitioned into 32 further subdivisions (not shown in FIG. 2D). One of these subdivisions corresponds to a sub-region represented by the alphanumeric character “y.” Such a subdivision can be uniquely specified within the Geohashing scheme by the address 9q8y.

FIG. 2E includes map 246, which illustrates subdivision 242, which corresponds to the Geohash address 9q8y and is one of the subdivisions of subdivision 232 (shown in FIG. 2D). Map 246 shows that there are, as with the other levels, 32 further subdivisions of 9q8y, ranging from addresses 9q8y0 to 9q8yz. One particular subdivision indicated in FIG. 2E is subdivision 248, which corresponds to Geohash 9q8ym (indicated by reference numeral 244) and covers Daly City, California.

FIGS. 2A-E thus illustrate that longer Geohashes can specify more precise geographic areas. As illustrated in FIG. 2A, a one-character Geohash can specify an area of approximately 5000 km², and thus cover a region covering much of the western half of the United States. On the other hand, a five-character Geohash can specify an area of approximately 4.9 km², and thus cover a relatively small portion of the San Francisco Peninsula as shown in FIG. 2E.

The Geohashing system thus allows arbitrary precision, based on the bit depth (i.e., length) of a particular address. Accordingly, given a starting Geohash corresponding to a particular region, precision can be added or removed by adding or removing a character. As has been illustrated, adding a character to a Geohash results in a smaller (and therefore more precise) geographic area. Conversely, removing one or more characters from a Geohash enlarges the region. Consider Geohash 9q8ym, which, as shown in FIG. 2E, is narrowly concentrated around Daly City, California. Removing the last four characters zooms the region out to top-level division 212, which corresponds to Geohash 9. The Geohash scheme is thus well-suited for implementing first address information 130 and second address information 140 shown in FIG. 1. Given a Geohash value of five characters computed at computing device 110, first address information 130 can be generated by simply truncating one or more bits of the address. For example, Geohash 9q8ym may be truncated to Geohash 9q8, such that “9q8” may be used as first address information 130, and “ym” may be used as second address information 140. First address information 130 can be referred to as a “coarse” portion of the Geohash, while second address information 140 may be referred to as a “fine” portion of the Geohash. Consider a six-character Geohash 9q8ymz. A coarse portion of this Geohash comprising its first three characters (“9q8”) would cover approximately 24,000 km², while a fine portion comprising the next three characters (“ymz”) can result in a Geohash (“9q8ymz”) that covers a significantly more precise area of approximately 1 km².

FIG. 2F summarizes several of the concepts described above. As shown, table 250 includes examples of first address information and second address information, all based on the five-character Geohash 9q8ym. Rows 252 and 254 show first address information at two characters of precision: 9q. Row 252 shows that second address information can be expressed as only the least significant characters (8ym) of the Geohash, while row 254 shows that second address information can be expressed as all the characters (9q8ym) of the Geohash. Rows 256 and 258 show the first address information at three characters of precision. As noted, “address information” is intended to be a broad phrase that encompasses a full address for LBI, a partial address for LBI, or information indicative of a full or partial address for LBI. For example, address information might cover a pointer to another data structure that stores a full or partial address. As will be described below, an encrypted version of second address information can include an encrypted bit vector indicating which one particular portion of a selected subset of LBI is requested by the device.

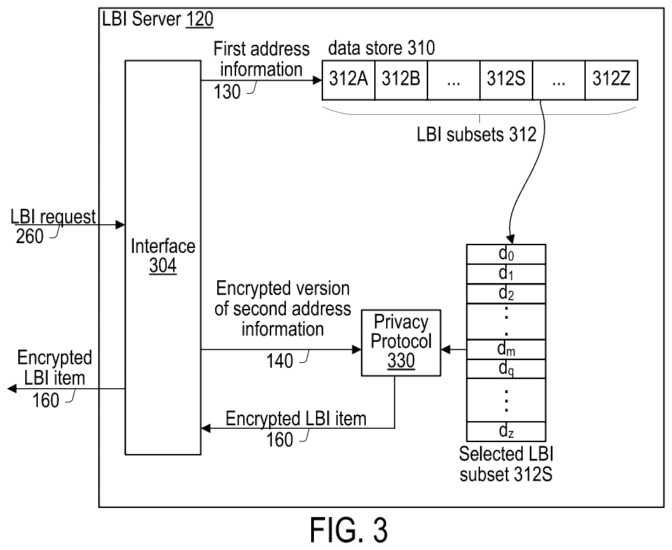

Still further, “address information” can constitute information derived from or indicative of an address. Second address information 140 in FIG. 2F is shown as comprising the remainder of the Geohash value (e.g., 8ym) in the implementations described with respect to FIGS. 3 and 4., but second address information 140 may take a different form. Specifically, second address information may constitute a bit vector that indicates which values (or values) within a larger set of values are to be retrieved by the LBI request. Consider a scenario in which first address information 130 has 4 characters of precision (e.g., 9q8y) and the entire Geohash has five characters of precision. In such an example, second address information 140 will need to specify only one of 32 entries (i.e., 9q8y0-9q8yz). Second address information may thus take the form of a bit vector with 32 entries, each corresponding to one of the 32 Geohash characters. In this particular implementation, all bit entries are set to zero except the one corresponding to “m,” which is set to one. The encrypted version of this form of second address information 140 will thus be an encrypted version of the bit vector. The utility of such an approach will be seen below with reference to FIGS. 3 and 4.

To preserve privacy, second address information (e.g., 8ym) is encrypted using a key that is not accessible by server 120. For example, this key may be stored securely at computing device 110 (e.g., in a secure computing element). This encryption prevents server 120 from learning the precise location of computing device 110 or the geographic area of interest. Note that the encryption may, in some cases, be a symmetric encryption in which both encryption and decryption are performed by the same key. In other cases, the encryption may be an asymmetric encryption in which the encryption and decryption are respectively performed by different keys.

FIGS. 2G-H show example request formats. FIG. 2G shows an example LBI request 260 from computing device 110 to server 120. Request 260 is delineated by the outermost set of brackets < > and includes first address information 130 (9q) and an encrypted version of second address information 140. But in some implementations, the entire request might be encrypted as well. Consider request 270 in FIG. 2H, which has the same content as request 260, but is encrypted in its entirety. In this scenario, the encryption of the entire request would be performed according to a (symmetric or asymmetric) encryption scheme (e.g., enc_120 in FIG. 2H) in which server 120 can decrypt request 270 itself. This approach results in a decrypted request in which first address information 130 is in the clear, and second address information 140 is encrypted in a manner not decryptable by server 120. FIG. 2G thus illustrates that first address information 130 may be sent to server 120 in encrypted form such as by using encryption function enc_120, but such form will be decryptable by server 120. FIG. 2H illustrates that second address information may be doubly encrypted (e.g., as a result of a secure connection between device 110 and server 120), but the innermost format (enc<8ym>) is in a form that is not decryptable by server 120. As will be described in the following figures, this paradigm exposes a coarse identification of a specified geographic location to server 120, without exposing a more fine-grain identification of such location.

Although Geohashing is particularly efficient for implementing the disclosed techniques, this disclosure is not so limited. Other formats for the first and second address information are also possible (e.g., other geospatial schemes similar to Geohashing, use of country codes and internal regional identifiers, etc.) Notably, the first and second address information can also be in different formats from one another. For example, first address information 130 might be a two-character alphanumeric country/region code, while second address information 140 might be a numerical identifier (or a full Geohash).

The use of first address information 130 and an encrypted version of second address information 140 to access LBI at server 120 will now be described with reference to FIG. 3. FIG. 3 is a block diagram of one embodiment of LBI server 120. As shown, FIG. 3 includes an interface module 304, which receives first address information 130 and an encrypted version of second address information as part of an LBI request. LBI server 120 includes a data store 310 that stores LBI. LBI server also includes a privacy protocol module 330, which in one embodiment implements a PIR protocol.

In a paradigm in which it is desired for a device such as computing device 110 to receive a specific one of multiple items from a remote server without the server having access to information indicating which item was accessed, a privacy protocol may be used. The inventors have recognized, however, that performing a privacy protocol such as PIR is computationally expensive and also affects latency. Consider a situation in which LBI server 120 stores weather data. In a five-character Geohash scheme, there are 325 (33,554,432) possible sub-regions, with many more regions when additional characters are used. Performing a PIR protocol on a data store with this number of entries would be impractical.

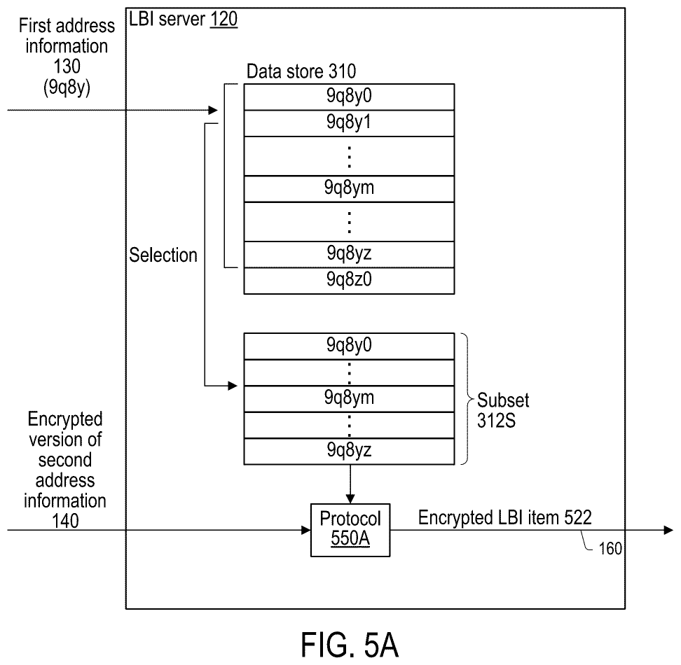

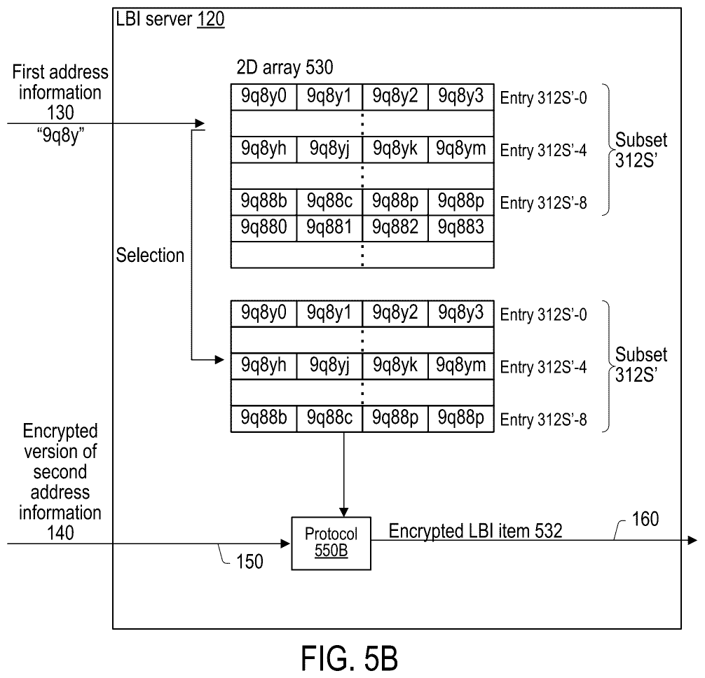

Recognizing this, the inventors propose a two-part addressing scheme. First address information 130 is sent to LBI server 120 in unencrypted format. As shown in FIG. 3, data store 310 can be divided into multiple subsets of data. One of these subsets can be selected using first address information 130. The reduction of the problem space for performing PIR depends on the size of first address information 130 relative to the number of entries in data store 310. Suppose a five-character Geohash is being used and there are 325 entries, each of which stores LBI for a single sub-region having a five-character Geohash (e.g., 9q8ym). (An alternative arrangement is discussed below with respect to FIG. 5B.) If first address information 130 is three characters long, data store 310 can be organized into 323 (32,768) subsets, each of which stores 322 (1,024) entries. In this arrangement, PIR would need to be performed only on the selected subset of 1,024 entries. If first address information 130 were four characters on the other hand, data store 310 can be organized into 32+(1,048,576) subsets, each of which stores 321 (32) entries. In this arrangement, PIR would need to be performed only on the 32 entries in the subset instead of 1,024 entries. The tradeoff here is between the amount of privacy desired for the user and the latency/complexity for the PIR computation. Using more characters in first address information 130 divulges more specificity about the desired location (e.g., the location of computing device 110), but speeds up and reduces the complexity of the PIR computation. Conversely, using fewer characters in first address information 130 divulges less specificity about the desired location, but slows down and increases the complexity of the PIR computation.

In addition to the design choice relating to the size of first address information 130, data store 310 can also be implemented in any suitable manner. In general, data store 310 can be any structure that can receive an address and return information based on the address. Data store 310 may thus be implemented as an array, a database, a key-value store, a dictionary, etc.

In the embodiment shown in FIG. 3, handling of the LBI request begins with receipt of the request by interface module 304, which handles communication between LBI server 120 a device that requests LBI (e.g., computing device 110). Interface module 304 receives LBI request 260 and separately sends first address information 130 and encrypted second address information 140. In some implementations, LBI request 260 may be encrypted (e.g., as part of an SSL protocol as shown in request 270 of FIG. 2H) and interface module 304 may perform decryption of the overall request. (In such a case, the result of the decryption will still be an encrypted version of second address information 140). First address information 130 may be used to address data store 310 and select a subset of LBI as described above. Although an arrow for selected subset 312S is shown connecting data store 310 and privacy protocol module 330, in some embodiments, selected subset 312S may be returned to interface module 304, allowing module 304 to call the protocol of module 330 by providing both selected subset 312S and the encrypted second address information 140. Note that while LBI request 260 is depicted in FIG. 3, any suitable format of the request is contemplated by the present disclosure.

Privacy protocol module 330, which is described in greater detail with respect to FIG. 4B, can then perform privacy computations on the selected subset. Significantly, LBI server 120 performs, using module 330, a protocol that uses the encrypted version of second address information 140 to produce an encrypted version of the desired item of LBI with LBI server 120 having access to information that indicates which item of LBI was specified in LBI request 260. As an example, LBI server 120 would have access to first address information 130 indicating Geohash 9q8y, but would not know the further sub-region (e.g., Geohash 9q8ym) that the user of computing device 110 is interested in (or is currently located in geographically). Module 330 returns an encrypted version of the desired LBI item 160 to interface module 304, which can then send it back to computing device 110.

As described above, one possible type of LBI stored in data store 310 is weather data. This type of data can include weather conditions (current temperatures, daily highs and lows, conditions, weather alerts, radar data, etc.). But LBI server 120 can store any suitable type of data in a setting in which a user of computing device 110 may wish to preserve a measure of privacy. For example, data store 310 may store map and navigation data, including traffic and road conditions. Similarly, data store 310 can store tracking data (e.g., friends and family). Data store 310 can also store LBI for various information services, such as listings of nearby ATMs, gas stations, travel information, medical facilities, restaurants, city guides, ride share data, service providers, etc. Many other types of LBI are possible, including mobile advertisements and social networking data (e.g., nearby friends/possible social contacts, recommending nearby social events). LBI can also be associated with any number of games, including ones in which a user's location is part of the gameplay.

It is also the case that the LBI for a particular Geohash region stored in data store 310 can include multiple types of data. For example, in some implementations, LBI request 260 might retrieve not only weather data, but also traffic data, and data related to nearby essentials, including food, ATM, gas, etc. The format of the data can also vary widely and be of mixed types, as the LBI can be in any known data format (e.g., text, image, audio, video, or any combination thereof).

As has been noted, Private Information Retrieval (PIR) protocols allow a user to retrieve a desired data item from a database or other data store, such that the server storing the database does not gain information on the identity of the item being retrieved. For example, an investor might want to know the value of a specific stock without revealing which stock is of interest. The general problem was introduced in work by B. Chor, O. Goldreich, E. Kushilevitz, and M. Sudan in the 1990s. In formalizing the problem, it is convenient to model the database by an n-bit string x, where the user, holding some retrieval index i, wishes to learn the i-th data bit xi. A trivial solution to the PIR problem is to send the entire database x to the user. While this solution is perfectly private, its communication complexity may be prohibitively large.

There are numerous variations of PIR as it is the subject of much research—thus there is no single PIR protocol. For example, in a t-private, k-server PIR protocol, a database is replicated among k servers, and the user's privacy is protected from any collusion of up to t servers. For purposes of this disclosure, a “privacy protocol” or “privacy retrieval protocol” is any algorithm, including any PIR protocol, that permits retrieval of information from a server in a manner that seeks to limit the likelihood that the server can learn the identity of the requested data. As is understood in the art, a privacy retrieval protocol does not require a guarantee of absolute privacy—such a guarantee cannot usually be made except in the trivial solution described above. In some cases, for example, a privacy guarantee may be made for computationally bounded servers (i.e., an assumption is made that there are finite limits to the processing power of the server(s) storing the data).

FIGS. 4A-B are used to illustrate a simplified version of one embodiment of a single-server PIR solution. For this reason, the embodiment is naturally described as being on “a” server and in “a” data store. But because multi-server privacy retrieval protocols are contemplated, references in this disclosure to a computer server are understood to encompass a server system with distributed component servers. Similarly, references to a data store should be understood to encompass a distributed data store or database. FIG. 4A is used to explain operations occurring on the computing device that prepare the encrypted version of second address information 140 included in LBI request 260. FIG. 4B describes one approach for protecting the identity of the requested data at LBI server 120.

FIG. 4A is a block diagram of one embodiment of a system 400 for generating an encrypted version of second address information 140 within computing device 110 in order to facilitate a privacy protocol such as PIR being performed at LBI server 120. As shown, system 400 includes encryption module 410 and secure element 420. In one implementation, encryption module 410 is indicative of functionality implemented in software that runs on central processing cores to communicate with a secure element circuit 420 that is implemented in hardware and is configured to perform various cryptographic operations including encryption. Other implementations are contemplated.

This Figure continues the use of the previous example, in which the five-character Geohash 9q8ym is split into a coarse portion (9q8y) and a fine portion (m). In this example, coarse portion 9q8y has been used to select an LBI subset (e.g., subset 312S) that has 32 items of LBI (denoted by 0-9 and the lowercase alphanumeric characters excluding “a,” “i,” “l,” and “o” in one embodiment). The objective of the privacy protocol in this example, then, is to request the m-th item in subset 312S without LBI server having access to information indicating that this item was requested.

As shown, encryption module 410 receives the fine portion of a Geohash address (“m”), as indicated by reference numeral 412. This value is passed to a decoder function 413 that produces a 32-value bit vector 414. In one embodiment, the value “m” is indicated by all values in bit vector 414 being equal to zero except for the m-th bit, which is set to one. Each bit in bit vector 414 is then encrypted using an encryptor module 415. Encryptor 415 sends a series of encryption requests 421 to secure element 420 for each bit in bit vector 414. Thus, encryption request 421 for the bit at index 2 will be a request to encrypt a zero, while encryption request 421 for the bit at index m will be a request to encrypt a one. Secure element 420 encrypts the requests using a key available to device 110 but not server 120. For example, the encrypting key may be available only to secure element circuit 420. After encrypting each request 421, secure element 420 returns the encrypted results as encrypted bits 422. After receiving encrypted bits 422, encryptor module 415 creates an encrypted vector 416 whose values are all encrypted values of 0, except for the value at selected bit 416m “m,” which is an encrypted value of 1.

Encrypted vector 416 now constitutes an encrypted version of second address information 140. It can thus be used along with first address information 130 as part of LBI request 260.

In the depicted embodiment, secure element 420 uses homomorphic encryption to create encrypted vector 416. Homomorphic encryption is a form of encryption that permits an entity to perform computations such as arithmetic operations on encrypted data without having the relevant keys for decryption. Consider a set of homomorphically encrypted numeric values N available to an entity E that does not have access to the key that can decrypt N. Because of the use of homomorphic encryption, entity E can perform an arithmetic operation (such as multiplying each value in N by two) on the encrypted data without the key(s) being involved in encrypting N. The values N (each now doubled) can subsequently be retrieved and decrypted.

Various types of arithmetic operations can be performed on homomorphically encrypted data. For example, multiplication can be performed as described below in connection with the sample PIR protocol of FIG. 4B. Two properties of multiplication of homomorphically encrypted data are of relevance here. First, the product of a homomorphically encrypted 0 and any number is a homomorphically encrypted 0. Note that homomorphic encryption is random, which means different instances of Enc(0) (where Enc refers to homomorphic encryption) are unlikely to produce values that are equal to one another. Otherwise, if all instances of Enc(0) produced the same value, server 120 could easily ascertain which index is Enc(1), thereby breaking security. Despite the difference in each instance of Enc(0), homomorphic decryption (Dec) ensures that any homomorphic encryption of 0 will be decrypted to a 0. Thus, for a given Enc(0), Enc(0)*K, where K is an integer, will produce a value that, when homomorphically decrypted, is 0. In other words, Dec(Enc(0)*K)=0 for any use of Enc on the value 0.

Second, the product of a homomorphically encrypted 1 and N is a homomorphically encrypted N (i.e., Enc(1)*N=Enc(N)). The same caveats noted above apply here: a given instance of homomorphic encryption of 1 (or N) is unlikely to yield the same value as another instance of homomorphic encryption of the same value. Additionally, encrypted values A and B can be summed to create an encrypted version of A+B. This means that the sum of a homomorphically encrypted zero and an encrypted number, when decrypted, outputs the unencrypted original number (i.e., Dec(Enc(0)*K+Enc(N))=N).

FIG. 4B is a block diagram of one embodiment of privacy protocol module 330 within LBI server 120. As has been described, LBI server 120 receives LBI request 260 that includes first address information 130 and encrypted version of second address information 140. First address information 130 is used to select subset 312S from data store 310, which is then provided to module 330, along with encrypted version of second address information 140, which in this embodiment is homomorphically encrypted vector 416.

As indicated by reference numeral 426, privacy protocol module 330 operates to multiply each element of encrypted vector 416 with the corresponding entry in LBI subset 312S. Accordingly, the 0^{th} entry of bit vector 416 (an encrypted version of zero) is multiplied by the 0^{th} entry of subset 312S (do). The product, which in this case is an encryption of 0 because the product of a data value and a homomorphically encrypted version of 0 is an encrypted 0, is placed in the 0^{th} entry of product array 430. This process occurs for each element of encrypted vector 416 and each corresponding element of subset 312S. For example, bit 416m, which is an encrypted version of one because it indicates the desired LBI element, is multiplied by the value of the desired element (dₘ of subset 312D), thus producing an encrypted version of dₘ at index m of product array 430. (Recall that Dec(dₘ*Enc(1))=dₘ.)

At this point, the element-wise multiplication of bit vector 416 and subset 312S has been performed, with the results stored in product array 430. Next, the elements of product array 430 are summed, as indicated by reference numeral 428. Because only the m^{th} bit, corresponding to element 416m, was set at device 110, there is only one encrypted version of a non-zero value in array 430: Enc(dₘ) at index m (with the remaining values being encrypted versions of zero). Accordingly, the sum of the elements of array 430 is equal to dₘ when decrypted. (Recall that Dec(Enc(dₘ)+K*Enc(0))=dₘ.) The encrypted version of dₘ is then output by module 330 as encrypted LBI item 160.

Significantly, the encrypted version of dₘ is encrypted within the ciphertext space of the encrypting key, since homomorphic encryption preserves the properties of the encryption functions. Accordingly, Enc(dₘ) may be decrypted with a key (e.g., a symmetric key (which may be referred to as a “secret key” in some contexts), an asymmetric secret key) that is not accessible to server 120. The properties of homomorphic encryption thus allow computing device 110 (specifically secure circuit 420 in one embodiment) to decrypt encrypted LBI item 160, even though key(s) of device 110 are not accessible to privacy protocol module 330. The operations of the privacy protocol in module 330 are thus performed in ciphertext space. LBI server only “sees” encrypted vector 416 at the input and encrypted LBI item 160 at the output of module 330, neither of which it can decrypt. PIR thus assures privacy as to which item of subset 312S has been selected.

FIGS. 4A-B have described a single-server PIR implementation. Note that this example has been provided for illustrative purposes, and is not intended to limit the details of how PIR might be implemented in various embodiments. For example, the implementation in FIGS. 4A-B could be considered inefficient in terms of upload communication in that includes only one ciphertext per database entry. Other implementations might include further efficiencies, such as uploading a compressed version of the encrypted zeros and ones, which can be decompressed into a vector of encrypted zeros and ones by LBI server 120, and utilizing Single Instruction Multiple Data (SIMD) plaintext packing functionality within the homomorphic encryption scheme to reduce computational cost. In other embodiments, a multi-server PIR protocol may be used.

In general, any protocol that accomplishes the same end of concealing the identity of the requested item from LBI server 120 may be employed. In some cases, a single LBI request from computing device 110 may be sent to multiple data stores 310 on LBI server 120, each storing a different type of LBI (e.g., traffic, weather, local merchant information). In other embodiments, a single LBI item within data store 310 may include the multiple different types of information in a format that can be parsed by computing device 110 after retrieval.

The preceding figures have described how LBI server 120 receives an LBI request and returns an encrypted version of the requested LBI. FIGS. 5A-B illustrate different ways in which data store 310 within server 120 may be organized. As will be shown, the organization of data store 310 can affect the content of the LBI that is returned to computing device 110.

FIG. 5A illustrates an embodiment in which data store 310 within LBI server 120 is organized as a one-dimensional array. As shown, data store 310 is addressed by first address information 130, which in this example is an unencrypted four-character Geohash address (9q8y). (Other precisions are possible). In response, particular subset 312S is selected. Particular subset 312S has 32 entries or elements, corresponding to 9q8y0 to 9q8yz. (Each of these entries is shown on a separate line in FIG. 5A.) Accordingly, encrypted LBI item 522 will be generated from the sum of the encrypted versions of all 32 entries of subset 312S using second address information 140 and protocol 550A, and resulting encrypted LBI item 160 can be decrypted by computing device 110 to produce a single item of LBI, the one corresponding to Geohash 9q8ym. Note that while only 32 bits of information are encrypted, the size of the ciphertext may be much larger (e.g., several KB). For this reason, data store 310 can be considered to have one dimension, as each entry includes LBI for one sub-region having a five-character Geohash. For example, this organization of data store 310 means that if computing device 110 moves out of the current sub-region (e.g., to a sub-region corresponding to Geohash 9q8yn), then another LBI request would need to be made to LBI server 120.

An alternate approach is shown in FIG. 5B, in which data store 310 within LBI server 120 is organized as a two-dimensional array. Again, data store 310 is addressed by first address information 130 corresponding to Geohash address 9q8y. Particular subset 312S′ is selected as a result. Subset 312S′ has the same overall content as subset 312S in FIG. 5A, but it is organized differently. Where subset 312S had 32 different entries for each possible sub-region within the area corresponding to Geohash 9q8y, subset 312S′ has 8 different entries. Entry 312S′-0, for example, has LBI for 4 different sub-regions within the larger area corresponding to Geohash 9q8y (e.g., 9q8y0, 9q8y1, 9q8y2, and 9q8y3). The requested LBI might be in entry 312S′-4, which could include LBI. This arrangement means that an encrypted bit vector needs to encrypt only 8 bits of information. (As noted above, the size of the corresponding ciphertext for a given encryption may be much larger.) Encrypted LBI item 532, then, can be generated using protocol 550B and second address information 140, sent as encrypted LBI item 160, and subsequently decrypted by computing device 110 to produce four items of LBI, corresponding to Geohashes 9q8yh, 9q8yj, 9q8yk, as well as for the specifically requested Geohash, 9q8ym. For this reason, this implementation of data store 310 can be said to have two dimensions. An advantage of this approach is that the extra entries can be cached by computing device 110. After a request for Geohash 9q8ym is satisfied, a subsequent request (perhaps within some designated time period) for LBI for, say, Geohash 9q8yk can be fulfilled without having to contact LBI server 120. Another advantage of the two-dimensional approach is that it further minimizes the complexity of the privacy protocol (and thus can improve performance). In the organizational scheme of FIG. 5A, PIR needs to be performed on 32 entries of 1 LBI item each, but in the organizational scheme of FIG. 5B, PIR need only be performed on 8 entries of 4 LBI items each.

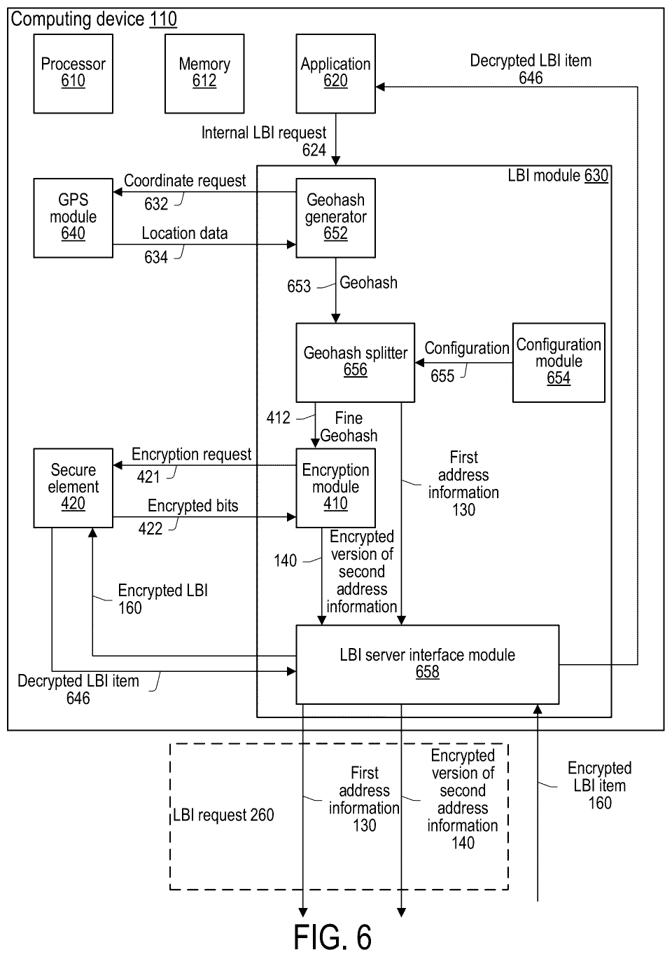

FIG. 6 illustrates a block diagram of one embodiment of computing device 110 that is configured to send an LBI request 260 to LBI server 120. Computing device 110 may be any suitable type of computer system. But the teachings of the present disclosure are particularly applicable to mobile computing devices such as mobile phones, tablets, laptops, and wearables since users of these devices are more likely to be requesting LBI.

As shown, computing device 110 includes a variety of hardware elements, including processor circuit 610, GPS module 640, secure element 420 and memory 612. Processor circuit 610 represents the central processing unit (CPU) capability of computing device 110, and may include one or multiple processing cores. Memory 612 is intended to represent both volatile and non-volatile storage in the context of FIG. 6. Memory 612 stores program instructions executable by processor circuit 610 to various programs and processes. In the depicted embodiment, memory 612 stores program instructions executable to implement an LBI module 630 that can handle requests from various applications (e.g., application 620) for LBI. In other embodiments, the functionality of LBI module 630 could be incorporated into an application 620. For example, application 620 might be a weather application and thus include code that acts as an interface to LBI server 120.

As shown, application 620 initiates an internal LBI request 624 to LBI module. Request 624 might indicate which type of LBI is requested, which would allow LBI module 630 to appropriately address LBI request 260. Thus, a request for weather LBI might go to one LBI server, while a request for traffic LBI might go to another server.

The receipt of LBI request 624 by LBI module initiates the process of generating LBI request 260. In the depicted embodiment, a Geohash generator module 652 obtains the current geographic location of computing device 110. This may be accomplished by requesting coordinates from other on-board resources, for example, GPS module 640. (Location information may also be obtained in other manners, such as by a determination of relative cellular signals.) But in the illustrated embodiment, module 652 sends coordinate request 632 to GPS module 640, and receives location data 634 in response. Location data 634 is common latitude and longitude coordinates, but other formats are possible. Module 652 is then executable to produce a Geohash 653 indicative of the current location of computing device 110, according to a known methodology specified by the Geohash standard. (Geohash generator 652 may also make an external call to a third-party server to calculate Geohash 653.) As noted, each Geohash character is one of 32 alphanumeric characters, which allows the current location to be specified with great specificity. For example, Geohash 653 might be specified to 12 characters in one implementation. As noted, in some instances, LBI request 260 might specify a geographic location of interest that is different from the user's current location. In such instances, alternate means may be employed to obtain latitude/longitude values for the location of interest.

Rather than having a one-size-fits-all approach to LBI requests, it may be desirable to be able to configure the amount of precision in LBI request 260. This functionality is represented by configuration module 654. Suppose Geohash 653 is 12 characters in length. Configuration module 654 may indicate that the coarse and fine portions of Geohash 653 to be included in LBI request 260 are 5 characters and 2 characters, respectively. Such a decision may be made based on a variety of factors. In some cases, this precision may be a user preference, and thus selectable within the settings of computing device 110. This allows a user to specify the degree of precision with which the location of interest (e.g., current location) is revealed. In other implementations, application 620 may specify the amount of precision to be employed as an argument of LBI request 624 that is conveyed to configuration module 654. In other implementations, the current location of computing device 110 might dictate the amount of precision. For example, the user or a default setting might specify that within certain boundaries, a particular degree of Geohash precision is to be used, while in other locations, some other, different precision is used. The amount of permitted precision may also be selected to comply with relevant regulations of the current jurisdiction. Because different precision criteria might be present at the same time, a hierarchy of which configuration specifications have priority over others might also be set. In other embodiments, configuration module 654 is not used and Geohash splitter 656 simply uses predetermined first and second address information depths.

Geohash splitter module 656 takes Geohash value 653 and splits it according to configuration data 655 supplied by configuration module 654. For example, suppose configuration data specifies 4/1 precision (4 characters of coarse address, 1 character of fine address) Thus, splitter module 656 might output “9q8y” as first address information 130 (or coarse Geohash) and “m” as fine Geohash 412 (also referred to throughout this disclose as second address information 140).

While first address information 130 can directly be included in LBI request 260, in one embodiment, fine Geohash 412 is processed by an encryption module 410 to create encrypted vector 416 as described above with reference to FIG. 4A (also referred to as the encrypted version of second address information 140). Vector 416 can be created by encryption module 410 by communicating with secure element 420. Secure element 420 is representative of any processor that is specifically configured to securely perform cryptographic operations, for example, by using keys that are not accessible outside element 420. In particular, secure element 420 may be configured to perform various homomorphic encryption and decryption operations.

As described with reference to FIG. 4A, encryption module 410 may assemble encrypted vector 416/encrypted version of second address information 140 by making a series of encryption requests 421 to secure element 420 and receiving encrypted bits 422 in response. As noted, one of encrypted bits 422 may be an encrypted 1, while the remaining elements of 422 may be encrypted versions of 0. Note that the encrypted version of a 1 or a 0 may be many bits long, depending on the encryption scheme. In other embodiments, cryptographic operations may be performed by module 410 without the assistance of secure element 420.

LBI server interface module 658, as shown, is responsible for interacting with LBI server 120 to retrieve and decrypt the LBI. Upon receiving first address information 130 and encrypted version of second address information 140, module 658 packages this information in LBI request 260. (Request 260 may also include additional information, such as that needed to appropriately address LBI server 120.) Thus, module 658 may communicate with server 120 using unencrypted HTTP requests in some embodiments, while in other embodiments, module 658 uses an SSL layer on top of LBI requests for additional security. In response to receiving LBI request 260, LBI server generates encrypted LBI item 160, which is returned to module 658. In one embodiment, module 658 makes a request to secure element 420 to generate decrypted item 160 using the same key that was used to encrypt bit vector 416/encrypted version of second address information 140. (But in other embodiments, secure element 420 uses asymmetric encryption and instead uses different keys for encryption and decryption.) Secure element 420 returns decrypted LBI item 646, which is returned to application 620 responsive to LBI request 624.

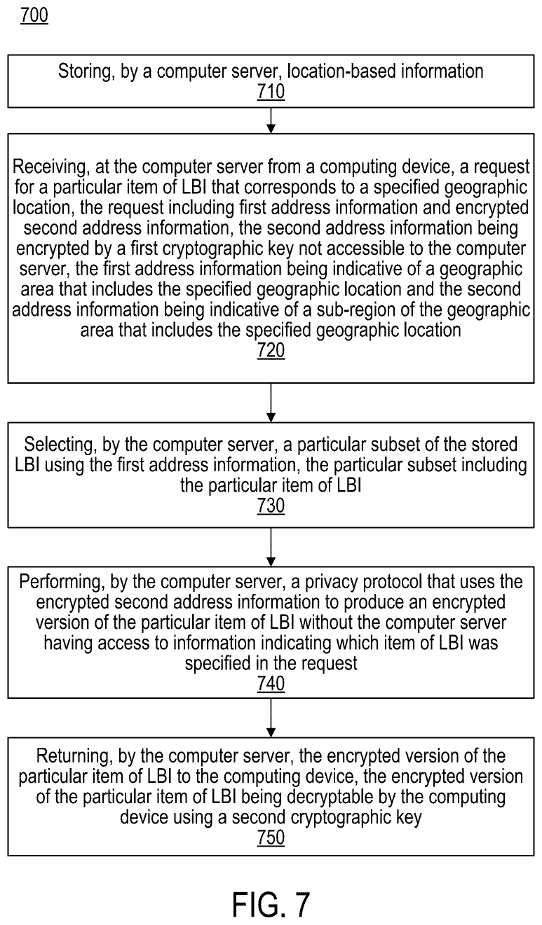

FIG. 7 is a flow diagram of a method 700 performed by a server storing location-based information.

Method 700 commences in 710, in which the server stores location-based information (LBI). The LBI in question may be any type of data—for example, weather data, traffic data, data relating to local services (e.g., restaurants, hotels). In some embodiments, the server may store multiple types of LBI, each of which can be accessed separately. Further, a particular item of LBI (i.e., LBI for a specified geographic area) can have any suitable data format. LBI might constitute textual data (e.g., high and low temperatures for a weather forecast). But the present disclosure is not limited to only textual data; other formats, such as image data can also be stored by the LBI server. For example, LBI server might store a list of nearby restaurants, as well as images depicting restaurant menus or images of the restaurants.

The server can store LBI in various ways. In some implementations, the server has a data store that includes a plurality of entries, where each entry stores an LBI for a single geographic region (typically the smallest geographic region that can be specified for the LBI at the current level of precision for the LBI address). This can be thought of as a one-dimensional LBI array. Alternatively, the data store may include a plurality of entries, where each entry stores LBI for multiple geographic areas.

In many cases, the multiple geographic areas may be contiguous. Accordingly, the LBI for multiple geographic sub-regions in a given entry of the data store may be cacheable by the computing device for future LBI requests. Thus, if LBI for two or more geographic sub-regions are returned in response to a particular LBI request, a subsequent LBI request from a different sub-region may be able to be satisfied from a cache of LBI on the computing device, obviating the need to contact the server.

Method 700 continues in 720, in which the server receives, from a computing device, a request for a particular item of LBI that corresponds to a specified geographic location (e.g., a current location of the computing device). The computing device will commonly be a mobile computing device such as a cellular phone, tablet, or laptop, whose location can easily change. As noted in the preceding paragraph, the particular item of LBI can be for various types of information. The request of method 700 includes first address information and encrypted second address information, where the second address information is encrypted by a first cryptographic key not accessible to the server. (Note that 720 does not preclude first address information being encrypted in some fashion. For example, the entire LBI request may be encrypted in a manner that is decryptable by the server; but once the LBI request is decrypted, the first address information may be unencrypted, but the second address information remains encrypted by a key that the server does not have access to.)

The first address information is indicative of a geographic area that includes the specified geographic location (e.g., the current location of the computing device), while the second address information is indicative of a sub-region of the geographic area that includes the specified geographic location e. For example, the geographic area indicated by the first address information might include the entire San Francisco Bay Area, while the sub-region of this geographic area indicated by the second address information might include only San Francisco proper.

In some implementations, the first address information and the second address information are portions of a geocode address that specifies the sub-region of the geographic area. One example of a geocode address is a Geohash value; the first address information can correspond to a coarse portion of the Geohash value, and wherein the second address information corresponds to a fine portion of the Geohash value. For instance, if a Geohash value has 8 characters; the coarse portion may correspond to the five most significant characters, while the fine portion is the three least significant characters. In another implementation, the first address information corresponds to a coarse portion of the Geohash value, while the second address information corresponds to the entirety of the Geohash value. The phrase “corresponds to” is intended to be construed broadly in this context, and can cover scenarios in which the second address information is a bit vector that is indicative of a Geohash value, as well as scenarios in which the second address information is the Geohash value.

The first address information and second address information may have different formats. For example, the first address information might specify a country code (e.g., US, GB), while the second address information might specify a postal code. Accordingly, a wide variety of possible formats for the first and second address information is contemplated.

Method 700 continues at 730, in which the server selects a particular subset of the stored LBI using the first address information, where the particular subset includes the particular item of LBI. As used herein, the term “subset” means a proper subset of the total stored LBI, such that a subset includes some but not all of the LBI at the server. By selecting only a portion of the LBI, this reduces the time that is needed to perform the protocol of 740.

In 740, the server performs a privacy protocol that uses the encrypted second address information to produce an encrypted version of the particular item of LBI without the computer server having access to information indicating which item of LBI was specified in the request. One example of such a privacy protocol is a PIR protocol, of which there are several varieties. For example, the PIR protocol can be a single-server protocol or a multi-server protocol.

The particular subset of LBI may have a first number of LBI entries, and the second address information may include a bit vector with a set of encrypted values, each of which corresponds to one of the first number of LBI entries. (As an example, if the particular subset includes 16 entries, the bit vector would include 16 encrypted values.) In the bit vector, a particular one of the set of encrypted values indicates that a corresponding entry in the particular subset stores the particular item of LBI. Thus, if the second address information indicates that the tenth of the 16 entries in the subset is the one that is requested, the (encrypted) tenth entry in the bit vector would indicate this. Remaining entries in the set of encrypted values in the bit vector would indicate that corresponding entries in the particular subset do not store the particular item of LBI.

The PIR protocol may be implemented in many different ways. In one embodiment, performing the PIR protocol includes (1) homomorphically multiplying each of the set of encrypted values by one or more corresponding entries in the particular subset, producing a set of products in ciphertext space and (2) and homomorphically summing products of the set of products to produce the encrypted version of the particular item of LBI in ciphertext space. As noted above, in a homomorphic encryption operation, multiplying an encoded zero (which indicates that an entry does not include the particular item of LBI) produces an encrypted version of zero, while multiplying an encoded one (which indicates that an entry does include the particular item of LBI) produces the encrypted version of the particular item of LBI. Summing the set of encrypted products again results in the encrypted version of the particular item of LBI. Due to the particulars of PIR, this encrypted version is encrypted in a manner that is decryptable by a second cryptographic key used to encrypt the second address information. Accordingly, in 750, the server returns the encrypted version of the particular item of LBI to the computing device, such that the encrypted version of the particular item of LBI is decryptable by the computing device using a second cryptographic key. Note that in some cases, the second address information is encrypted using a symmetric key, such that the first and second cryptographic keys are identical. But in other cases, the second address information is encrypted using an asymmetric key, such that the first cryptographic key is a public key used for encryption and the second cryptographic key is a corresponding private key used for decryption.

Note that the amount of precision of the address information in the LBI request may be user-configurable. That is, the computing device may permit the user to specify the precision of the first address information that is presented to the server (the second address information is encrypted and thus not available to the server in decrypted form). Accordingly, a user can specify, for example, whether 3, 4, or 5 bits (or any arbitrary number) of a Geohash value are to be sent to the server. The user can also specify the precision of the second address information depending on how large or small an area that is desired to be covered by the LBI.

As another possibility, the amount of precision with which the specified geographic location is set forth in the request may be set by a program executing on the computing device. Thus, different programs operating on the same computing device may specify different precisions within LBI requests. In a similar vein, the amount of precision with which the specified geographic location is set forth in the request is set based on the current location of the computing device. This may be controlled by the operating system of the computing device for example.

Method 700 and the described variations can be implemented by program instructions stored on a non-transitory computer-readable storage medium that are capable of being executed by a computer server. Note that in some cases, program instructions may be stored on a storage medium but not enabled to execute in a particular computing environment. Note that program instructions stored on a computer-readable medium can be said to “executable” to perform certain functionality, whether or not current software configuration parameters permit such execution. Executability means that when and if the instructions are executed, they perform the functionality in question. Similarly, a computer server that is configured to implement method 700 and the described variations is also contemplated.

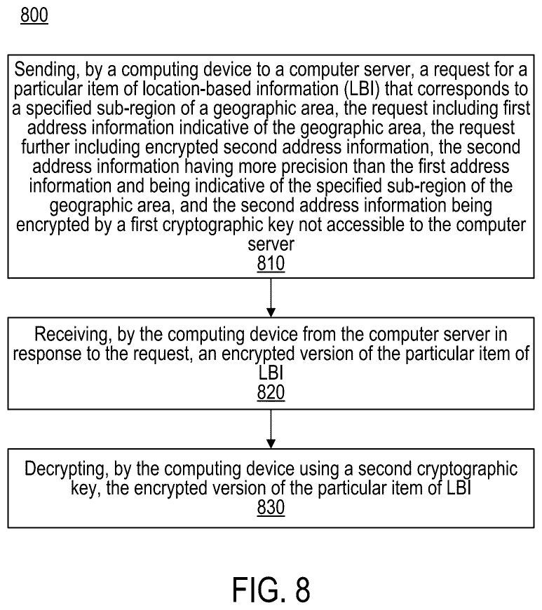

FIG. 7 describes a method that is performed by LBI server 120 in response to a request from a computing device such as computing device 110. FIG. 8, on the other hand, is a flow diagram of a method 800 performed by a computing device requesting location-based information from an LBI server. For example, method 800 may be performed by a mobile computing device such as a smart phone.

Method 800 commences in 810, in which the device sends, to a server, a request for a particular item of LBI that corresponds to a sub-region of a geographic area (e.g., a sub-region in which the device is located). For example, if the server stores LBI for a Geohash value having five characters of precision, the particular item of LBI can correspond to a five-character Geohash value. The request includes an encrypted version of second address information that precisely specifies a sub-region within a larger geographic area indicated by the first address information, which is also included in the request. (For example, the first address information might specify 3 characters of a Geohash value, while second address information might specify 2 additional characters.) The second address information is encrypted by a first cryptographic key not accessible to the server. In some cases, encryption of the second address information may be performed using a cryptographic circuit located on the computing device (e.g., a secure element module).

The computing device may, in some implementations, obtain initial location information using a hardware module (e.g., GPS receiver, WiFi card) or software that can retrieve location from IP addresses. Initial location information may be in any format that describes location (e.g., geohash, latitude/longitude). In some embodiments, the computing device converts the initial location information into the format of the first and second address information after obtaining it. For example, the computing device may receive latitude/longitude coordinates from a GPS module and convert it to a Geohash. This Geohash may be then split into two groups of bits, with the upper-order bits being used as the first address information indicative of a geographic area, and with the lower-order bits being used to generate the second address information. The precision of the first and second address information may also have amounts of precision configured by various entities (e.g., the user of the computing device, an application running on the computer device). In some cases, the amount of precision of the first and second address information may depend on the current location of the computing device.

Method 800 continues in 820, in which the computing device receives, from the server in response to the request, an encrypted version of the particular item of LBI. In some embodiments, the item of LBI is an individual item selected by the server using encrypted second address information (e.g., weather for a precise location of the computing device). The item may be retrieved using any protocol that takes in encrypted second address information and returns an encrypted version of the specific LBI. One example of such a protocol is a Private Information Retrieval (PIR) protocol.

In 830, the specific LBI item returned to the computing device is decrypted. The computing device decrypts the particular item of LBI item using a second cryptographic key. As noted, the first and second cryptographic keys may be the same cryptographic key when the second address information was encrypted using a symmetric encryption. But in the cases of asymmetric encryption, the first and second cryptographic keys are different. In some embodiments, the decryption may be made using a cryptographic circuit such as a secure element. The LBI item received may be a discrete item describing a single geographic location indicated by second address information, or multiple items describing the specific geographic location and additional nearby locations for potential caching by the device. For example, a device may cache LBI items for the current sub-region as well as LBI items for nearby sub-regions. This caching can be useful in the case that the device moves and needs new LBI, as that LBI can be retrieved from the cache without having to initiate a new LBI request.

Method 800 and the described variations can be implemented by program instructions stored on a non-transitory computer-readable storage medium that are capable of being executed by a computing device. Note that in some cases, program instructions may be stored on a storage medium but not enabled to execute in a particular computing environment. Program instructions stored on a computer-readable medium can be said to “executable” to perform certain functionality, whether or not current software configuration parameters permit such execution.

Similarly, a computing device that is configured to implement method 800 and the described variations is also contemplated.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript. An instance of a program being executed may be referred to as a “process.”

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

The present disclosure refers to various software operations that are performed in the context of any computing device that uses an operating system to run and schedule processes. Such a computing device can be configured according to any known configuration of computer hardware. A typical hardware configuration includes a processor subsystem, memory, and one or more I/O devices coupled via an interconnect. A given computing device may also be implemented as two or more computer systems operating together.

The processor subsystem of the computing device may include one or more processors or processing units. In some embodiments of the computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the computing device is usable to store program instructions executable by the processor subsystem to cause the computing device to perform various operations described herein. The system memory may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read-only memory (PROM, EEPROM, etc.), and so on. Memory in the computing device is not limited to primary storage. Rather, the computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. An apparatus, comprising:
a processor circuit; and
a memory storing location-based information (LBI) and instructions that are executable by the processor circuit to cause the apparatus to perform operations comprising:
receiving, from a computing device, a request for a particular item of LBI that corresponds to a specified geographic location, the request including first address information and encrypted second address information, the second address information being encrypted by a first cryptographic key not accessible to the apparatus, the first address information being indicative of a geographic area that includes the specified geographic location and the second address information being indicative of a sub-region of the geographic area that also includes the specified geographic location;
selecting a particular subset of the stored LBI using the first address information, the particular subset including the particular item of LBI;
performing a privacy protocol that uses the encrypted second address information to produce an encrypted version of the particular item of LBI without the apparatus having access to information indicating which item of LBI was specified in the request; and
returning the encrypted version of the particular item of LBI to the computing device without the sub-region of the geographic area being identifiable to the apparatus, the encrypted version of the particular item of LBI being decryptable by the computing device using a second cryptographic key.

2. The apparatus of claim 1, wherein the specified geographic location is a current location of the computing device.

3. The apparatus of claim 1, wherein the particular subset has a first number of LBI entries, wherein the second address information includes a compressed vector that, when decompressed, includes a set of encrypted values corresponding to each of the first number of LBI entries, wherein a particular one of the set of encrypted values indicates that a corresponding entry in the particular subset stores the particular item of LBI, and wherein remaining ones of the set of encrypted values indicate that corresponding entries in the particular subset do not store the particular item of LBI.

4. The apparatus of claim 3, wherein performing the privacy protocol includes:
homomorphically multiplying each of the set of encrypted values by one or more corresponding entries in the particular subset, producing a set of products in ciphertext space; and
homomorphically summing products of the set of products to produce the encrypted version of the particular item of LBI in ciphertext space.

5. The apparatus of claim 1, wherein the first address information and the second address information are portions of a Geohash value that specifies the sub-region of the geographic area.

6. The apparatus of claim 1, wherein the stored LBI includes at least one of the following types of data: weather data, traffic data, data relating to local services, and wherein the first and second cryptographic keys are the same key.

7. The apparatus of claim 1, wherein the particular item of LBI is stored in one of a plurality of entries of a data store, each of the plurality of entries storing LBI for multiple geographic sub-regions.

8. The apparatus of claim 1, wherein an amount of precision with which the specified geographic location is set forth in the request is configurable.

9. The apparatus of claim 8, wherein an amount of precision with which the specified geographic location is set forth in the request is configurable by a user of the computing device.

10. A non-transitory computer-readable medium having program instructions stored therein that are executable by a computer server to perform operations comprising:
receiving, from a computing device, a request for a particular item of location-based information (LBI) that corresponds to a specified geographic location, the request including first address information and encrypted second address information, the second address information being encrypted by a first cryptographic key not accessible to the computer server, the first address information being indicative of a geographic area that includes the specified geographic location and the second address information being indicative of a sub-region of the geographic area that also includes the specified geographic location;
selecting a particular subset of the stored LBI using the first address information, the particular subset including the particular item of LBI;
performing a privacy protocol that uses the encrypted second address information to produce an encrypted version of the particular item of LBI without the computer server having access to information indicating which item of LBI was specified in the request; and
returning the encrypted version of the particular item of LBI to the computing device, the encrypted version of the particular item of LBI being decryptable by the computing device using a second cryptographic key.

11. The computer-readable medium of claim 10, wherein the stored LBI includes image data, and wherein the privacy protocol is a Private Information Retrieval (PIR) protocol.

12. The computer-readable medium of claim 10, wherein the first address information and the second address information are portions of a Geohash value that specifies the sub-region of the geographic area.

13. The computer-readable medium of claim 10, wherein the particular subset has a first number of LBI entries, wherein the second address information includes a compressed vector that, when decompressed, includes a set of encrypted values corresponding to each of the first number of LBI entries, wherein a particular one of the set of encrypted values indicates that a corresponding entry in the particular subset stores the particular item of LBI, and wherein remaining ones of the set of encrypted values indicate that corresponding entries in the particular subset do not store the particular item of LBI.

14. The computer-readable medium of claim 13, wherein performing the privacy protocol includes:
homomorphically multiplying each of the set of encrypted values by one or more corresponding entries in the particular subset, producing a set of products in ciphertext space; and
homomorphically summing products of the set of products to produce the encrypted version of the particular item of LBI in ciphertext space.

15. The computer-readable medium of claim 10, wherein the amount of precision with which the specified geographic location is set forth in the request is set by a program executing on the computing device.

16. A method, comprising:
storing, by a computer server, location-based information (LBI);
receiving, at the computer server from a computing device, a request for a particular item of LBI that corresponds to a specified geographic location, the request including first address information and encrypted second address information, the second address information being encrypted by a first cryptographic key not accessible to the computer server, the first address information being indicative of a geographic area that includes the specified geographic location and the second address information being indicative of a sub-region of the geographic area that includes the specified geographic location;
selecting, by the computer server, a particular subset of the stored LBI using the first address information, the particular subset including the particular item of LBI; and
performing, by the computer server, a privacy protocol that uses the encrypted second address information to produce an encrypted version of the particular item of LBI without the computer server having access to information indicating which item of LBI was specified in the request; and
returning, by the computer server, the encrypted version of the particular item of LBI to the computing device, the encrypted version of the particular item of LBI being decryptable by the computing device using a second cryptographic key.

17. The method of claim 16, wherein the first address information and the second address information are portions of a Geohash value that specifies the sub-region of the geographic area, wherein the first address information corresponds to a coarse portion of the Geohash value and the second address information corresponds to a fine portion of the Geohash value.

18. The method of claim 16, wherein the particular item of LBI is stored in one of a plurality of entries of a data store, each of which stores LBI for multiple geographic sub-regions, and wherein the LBI for multiple geographic sub-regions in a given entry of the data store is cacheable by the computing device for future LBI requests.

19. The method of claim 16, wherein the first address information and second address information have different formats, and wherein the first cryptographic key and the second cryptographic key are different.

20. The method of claim 16, wherein an amount of precision with which the specified geographic location is set forth in the request is based on the current location of the computing device.
